(19) United States
(12) Patent Application Publication
(10) Pub. No.: US 2025/0277623 A1
(43) Pub. Date: Sep. 4, 2025

(54) RESIDUAL BIOMASSES MECHANICAL DRYER EQUIPMENT

(71) Applicant: FUNDICIONES UNIVERSO S.A.S., Acopi-Yumbo (CO)

(72) Inventor: Santiago Chavarro Gaitan, CALI (CO)

(21) Appl. No.: 19/068,578

(22) Filed: Mar. 3, 2025

Related U.S. Application Data
(60) Provisional application No. 63/560,415, filed on Mar. 1, 2024.

(51) Int. Cl. F26B 5/14; F26B 25/04

(52) U.S. Cl. CPC F26B 5/14; F26B 25/04; F26B 2200/02

(57) ABSTRACT

This invention comprises a residual biomass mechanical drying equipment that not only reduces the moisture content mechanically below 45% without resorting to dryers, but also solves the two problems involved in biomass from residual vegetables, given that its high level of humidity makes its use in boilers inefficient and expensive. The solution proposed by the equipment in this invention has a basic principle that is completely different from existing technological solutions, which work using hot gases and large tubular structures, and occupy large spaces in factories at high acquisition and maintenance costs. This equipment has the advantage of lower manufacturing costs, lower energy consumption, and less space used. Thus, having only two mobile elements (two cylinders), its energy consumption is much lower than that of traditional dryers, which have multiple parts and must support the weight of the biomass throughout its structure and move it permanently along its entire length.

### CROSS REFERENCE TO RELATED APPLICATIONS

This application claims benefit of U.S. Provisional Patent Application No. 63/560,415 filed Mar. 1, 2024, titled Residual Biomasses Mechanical Dryer Equipment, the disclosure of which is incorporated herein by reference in its entirety.

### a) FIELD OF THE INVENTION

This invention is within the technical field of equipment or systems used in the reconditioning or preliminary treatment of residual vegetable biomass from agro-industrial processes. It reduces its humidity and ensures the economically viable use of its calorific value as fuel for biomass boilers, which are generators of renewable and clean energy.

This invention is intended as a residual biomass mechanical drying equipment that not only reduces the moisture content below 45% mechanically without resorting to dryers, but also solves the two problems that biomass from residual vegetables has: Its high level of humidity makes their use in the boilers inefficient and expensive. The solution proposed by the equipment in this invention has a basic principle that is completely different from existing technological solutions, which work using hot gases and large tubular structures that occupy large spaces in factories with high acquisition and maintenance costs. This equipment has the advantage of lowering manufacturing costs, lowering energy consumption, and reducing the amount of space used. Thus, having only two mobile elements (two cylinders), its energy consumption is much lower than that of traditional dryers which have multiple parts and must support the weight of the biomass throughout their structure, move it permanently, and move it along its entire length.

### BACKGROUND OF THE INVENTION

The use of biomass as a raw material has been increasing to a great extent due to its great advantages when used as fuel, or in other industries altogether. Biomasses represent clear advantages when used as raw material in the manufacture of products such as paper, chipboard, animal feed, containers, and second-generation alcohol, among others, and by reducing CO₂ emissions (as compared to fossil fuels), reducing waste material, and reducing the dependence on polluting fuels.

Likewise, biomasses are the oldest sources of energy humanity has used, from the bonfires used by primitive humans to warm themselves to modern developments in which biomasses from different sources are used to produce energy, such as those from forests, the industrial use of various crops (fodder pastures, palm oil, sugar cane, etc.) and others, such as residues from livestock activities.

However, for biomass to be used efficiently and economically viable, it is essential to reduce its humidity before its combustion (biomass pretreatment) to levels that allow for its rational use as an energy source in industrial boilers. The problem is that part of its calorific value must be used to first reduce its humidity level, thereby generating inefficiency in the combustion process in the boilers. And although there are some systems or devices that allow for this reduction in the biomass moisture level, they have the drawback that they are too complex and are based on cumbersome systems that are specific to the type of biomass to be treated.

A typical example of residual biomass is sugarcane bagasse, whose grinding process is usually carried out in several mills installed in tandem (six mills with 4 rollers or toothed rollers each that work under compression). This process manages to extract a high percentage of the cane juice that residually reduces the humidity in the bagasse, with results that vary considerably among the different manufacturing facilities. This is due to factors such as the variety of sugar cane being processed, the amount of imbibition water added to the process to help extract sucrose, the mechanical state of the mills, the prevailing climate at the time of harvest, and so on. After using this process, the average percentage of humidity is around 50%. (Rein, P. Cane Sugar Engineering. 2nd. Edition. Verlag. Berlin 2017).

In this specific case, the problem is that the final bagasse from the grinding process in the six mills described above still has a high moisture content, which in some cases can exceed 50%. This is the cause of the greater loss of energy in the boilers, producing a decrease of approximately 196 Kilojoules per kilogram (KJ/kg) for every 1% increase in bagasse moisture. (Rein, P. Cane Sugar Engineering. 2nd. Edition. Verlag. Berlin 2017).

This high percentage of humidity causes inefficiencies inside the boiler that eventually force the use of additional fossil fuels, such as coal, to generate the ideal combustion conditions, since the humidity in the biomass (cane bagasse in this case) causes the temperature of the gases to decrease.

To emphasize the importance of pre-drying biomass, the following Table 1 shows both the savings in fuel and the increases in efficiency when steam is generated in the boilers (from 60.7% to 66.9% at 400° F. (204.4° C.)) (https://www.lippel.com.br/Assets/Downloads/16-07-2014-15-55influencia-del-secado-en-la-enficiancia-termica-de-generadores-de-vapor.pdf):

TABLE 1
BAGASSE DRYING INFLUENCE IN THE EFFICIENCY OF STEAM GENERATORS

| | FUEL | FUEL | STEAM GENERATOR | | | | |
|---|---|---|---|---|---|---|---|
| HUMIDITY (%) | CONSUMPTION | SAVINGS | EFFICIENCY (%) | | | | |
| WET BASE | T/day/10\hat{ }5 lb/h | T/day/10\hat{ }5 lb/h | 400° F. | 425° F. | 450° F. | 475° F. | 500° F. |
| 50 | 480.0 | 0.0 | 60.7 | 59.9 | 59.1 | 58.4 | 57.7 |
| 49 | 471.2 | 8.8 | 61.4 | 60.6 | 59.8 | 59.1 | 58.4 |
| 48 | 462.4 | 17.7 | 62.1 | 61.3 | 60.5 | 59.8 | 59.1 |
| 47 | 453.5 | 26.5 | 62.7 | 61.9 | 61.1 | 60.4 | 59.7 |
| 46 | 444.6 | 35.4 | 63.4 | 62.6 | 61.8 | 61.1 | 60.4 |
| 45 | 435.7 | 44.3 | 64.0 | 63.2 | 62.4 | 61.7 | 61.0 |
| 44 | 426.8 | 53.2 | 64.6 | 63.8 | 63.0 | 62.3 | 61.6 |
| 43 | 417.9 | 62.1 | 65.2 | 64.4 | 63.6 | 62.9 | 62.2 |
| 42 | 409.0 | 71.1 | 65.8 | 65.0 | 64.2 | 63.5 | 62.8 |
| 41 | 400.0 | 80.0 | 66.4 | 65.5 | 64.8 | 64.0 | 63.4 |
| 40 | 391.0 | 89.0 | 66.9 | 66.1 | 65.3 | 64.6 | 63.9 |

According to the aforementioned, it is clear that it is a crucial challenge to reduce the humidity of industrial residual biomass in a viable and efficient way to generate clean and renewable energy in biomass boilers. Moreover, the current dependence of close to 80% on non-renewable energy sources (oil, coal, and gas) demands it (https://www.csic.es/es/actualidad-del-csic/biorrefinerias-para-convertir-residuos-vegetales-en-combustible-renovable).

To continue with the example of biomass from sugarcane milling processes, the objective is to optimize its pre-drying and reduce its humidity in an economically viable way by substantially improving the efficiency of the boilers, until it reaches levels close to 40%. This, considering that the industry standard is 50%. Reaching levels close to 30% is not convenient due to the spontaneous combustion problems that could occur.

Likewise, Narendranath and Rao (2002) found in their research that with humidity percentages between 42 and 44%, the boilers showed an increase in their capacity of up to 8%. The foregoing, for sugar mills that process millions of tons of sugar cane per year, represents advantages of all kinds, both financial and in power consumption. Moreover, it has been established that a 1% reduction in bagasse moisture produces an improvement equivalent to 1% in boiler efficiency (Chen J C P and C C Choh. (1993), Cane Sugar Handbook, 12 ed. John Wiley and Sons).

The different alternatives that have been used to reduce the humidity of agro-industrial residual biomass, and specifically for the sugarcane juice extraction process, generate around thirty tons of bagasse for every 100 tons of ground cane. Here and for other kinds of residual biomass, the types of dryers are very similar. The following is a summary of the main technologies that have tried to solve the problem of drying residual plant biomass:
1.—Open-air drying
2.—Economizers (Heat Exchangers)
3.—Rotary dryers (direct or indirect combustion)
4.—Fluidized bed dryers
5.—Flash-type dryers

In this respect, Holmberg (H. Holmberg, “Biofuel Drying as a Concept to Improve the Energy Efficiency of an Industrial CHP Plant Improve the Energy Efficiency of an Industrial CHP Plant,” Helsinki University of Technology, 2007) has produced a complete classification of the types of current commercial dryers where it is important to highlight the fact that they do not include any mechanical solutions.

In fact, rotary bagasse dryers are the ones used the most for drying biomass. They generally consist of a bagasse feeding or inlet area, a rotating tube where the drying process takes place by injecting hot gas and using fans, special pipes, and conveyors with dimensions that can exceed 30 meters in length and high acquisition and maintenance costs that are not economically viable and that do not always generate a positive electric power balance.

At the same time, the boilers specially designed to process residual vegetable biomass have evolved while sacrificing efficiency to make them suitable for operating with relatively high humidity in the bagasse (around 52%) and thereby adapting to levels obtained in the biomass grinding process, such as that of sugarcane bagasse. However, the main problem is that the technological solutions to date (such as rotary dryers) that reduce the humidity of the agro-industrial residual biomass before entering the boilers have excessive costs and are too large, making their use unfeasible in the vast majority of cases.

Another problem found in current technologies is that commercial dryers are not designed to accommodate the type of residual biomass that is intended to be processed. Residual biomasses have very different physical characteristics. Sugarcane bagasse, for example, is very different from sawdust generated by a logging industry, malt bagasse from a brewery, or waste from an oil palm plantation processing plant. Biomasses differ according to their various properties, such as:
Final humidity from its previous process
Particle sizes
Density
Percentage of volatile material
Bio-corrosion (any damage to the metallic equipment in which it is processed)

Traditional drying solutions do not accommodate these different conditions, and it is common for problems to occur when they begin to generate, for example, extremely dry and volatile particles inside the dryers. These in turn cause potential risks which once inside the boilers, are extremely difficult to oversee. It is also the case that the acids generated by the biomass attack the elements of the rotary dryers, making the whole process costly and prone to stoppages.

Therefore, in current technologies, it is considered not possible to reduce the humidity level of the sugarcane bagasse below 45% by mechanical means. In fact, in the 16th International Drying Symposium (IDS 2008) held in Hyderabad, India in November 2008, Shingare and Thorat presented a paper on the “DRYING OF SUGAR CANE BAGASSE,” where they concluded that “ . . . reducing humidity by mechanical methods is possible by rolling the bagasse through several mills in successive stages to reduce humidity to possibly 45-46%,” while “The reduction of the moisture content below 45% is possible only by using dryers. Wet bagasse drying involves the transfer of heat to evaporate moisture . . . ” (https://www.researchgate.net/publication/351091237_SUGAR_CANE_BAGASSE_DRYING_-A_REVIEW).

Likewise, it is clear then that traditional methods to reduce humidity such as rotary dryers do not generate a positive energy balance since they use larger amounts of energy (in many cases non-renewable). Furthermore, traditional moisture reduction methods cannot be adapted to the different physical and chemical characteristics of different biomasses, which creates further potential problems in their treatment.

Therefore, it is clear that the existing problem is that the current solutions are too expensive, take up too much space in the plants, and cannot be adapted to the different types of biomasses that are available.

From the information above, it is also clear to any person skilled in the subject that there is a prevalent need to design and implement equipment to overcome the existing problems with devices or systems that lower costs and the level of humidity in the biomass. It is also important to have equipment or apparatus of adequate size for any production plant and that it be versatile so that it can be adapted to any type of biomass currently available, without limitations.

### SUMMARY OF THE INVENTION

Considering the aforementioned problems and/or needs, the inventors have proposed a new mechanical dryer equipment for residual biomass which allows reducing the moisture content below 45% mechanically without resorting to dryers, while solving the two problems that residual plant biomasses have due to their high level of humidity: their use in boilers being inefficient and expensive.

The equipment for this invention is based on a basic principle that works without the use of hot gases, large tubular structures that occupy large spaces in factories, and with a considerably low manufacturing and maintenance cost as to what is currently available in the market. This equipment has the advantage of having a low energy consumption and occupying much less space in a processing plant.

The equipment of the invention is based on the operation of only two mobile elements that correspond to two cylinders, lowering energy consumption as compared to traditional dryers. The latter dryers have multiple pieces and must support the weight of the biomass throughout their entire structure and move it permanently along their entire length.

Specifically, the biomass drying equipment in this invention is a mechanical device that works with electric or hydraulic motor-reducers that rotate two metallic pressure cylinders, alternately cast in different materials depending on the characteristics of the biomass being processed, such as cast iron, alloy cast steel, or stainless steel. Eventually, the rollers can also be manufactured in high-performance plastics, depending on the biomass being processed, assembled on their respective axes, and mounted on two metal housings. These cylinders, grooved or toothed in such a way as to ensure the highest compression according to the physical conditions of the biomass being processed, have special patented nozzles inserted into perforations made on the body of the cylinders, radially oriented and connected to liquid drainage evacuation passages of the perforated biomass along the length of the cylinder.

The nozzles, each equipped with multiple conical perforations (more than one), capture and direct the liquid in the biomasses compressed between these two grooved cylinders. The divergent internal geometry of each of the nozzle perforations prevents clogging. The equipment may have the optional possibility of being manufactured with a hydraulic headstock system to maintain constant compression between the two rollers.

With the above and other objects in view there is provided, in accordance with the invention a residual biomass mechanical dryer assembly that includes metallic pressure cylinders each having a respective motor for rotation thereof. The cylinders each have a respective body and axis and are mounted on metal housings. The cylinders are grooved or toothed and the cylinders each have axially extending ducts formed in the body to drain biomass liquids. The cylinders have radially extending perforations extending between an outer surface thereof and the ducts. Nozzles are disposed in the perforations. A vertical feeder is located over the cylinders. The vertical feeder have a scraping cleaning element on a lower part thereof. A lower outlet for separated dry biomass. A reservoir is located laterally to the cylinders and is fluidically connected to the ducts. A liquid biomass outlet hose is connected to the reservoir.

It is accordingly a further object of the invention, that the cylinders are made of cast iron, alloy cast steel, stainless steel, high-performance plastics, or combinations thereof.

In accordance with an added feature of the invention, the removable nozzles are each provided with conical perforations.

In accordance with an additional feature of the invention there is a biomass push system for the constant feeding of the cylinders.

In accordance with yet an additional feature of the invention, there is a lower outlet with a conductive element that receives the dry biomass that falls by gravity and transports it to a boiler.

In accordance with yet another added feature of the invention, the reservoir can be connected to a vacuum pump.

In accordance with still another added feature of the invention, there is a hydraulic headstock system that maintains constant compression between the rollers.

In accordance with still another added feature of the invention, there are tracks or lateral guides for positioning the cylinders.

### BRIEF DESCRIPTION OF THE DRAWINGS

This invention is understood more clearly by referring to the following diagrams where the components associated with this equipment, device, and/or apparatus are depicted, as well as the novel elements with respect to current technologies.

The diagrams are not intended to limit the scope of the invention, which is solely given by the attached claims, where:

FIG. 1 is top view of the residual biomass mechanical dryer equipment;

FIG. 2 is a perspective view of one of the cylinders of the dryer equipment of FIG. 1, including a feeder element;

FIG. 3 is a perspective view of one of the cylinders of the dryer equipment of FIG. 1, including guides or lateral tracks for cylinder movement;

FIG. 4 is a schematic view showing a preferred location of the biomass drying equipment for this invention in a conventional sugar mill line;

FIG. 5 is a comparative representation of the dimensions of a typical commercially available rotary dryer next to the dryer equipment of FIG. 1;

FIG. 6 is a perspective view of one of the cylinders of the dryer equipment of FIG. 1;

FIG. 7 is a perspective view with a cutout of one of the cylinders of the dryer equipment of FIG. 1; and

FIG. 8 is another perspective view of the dryer equipment of FIG. 1;

### DETAILED DESCRIPTION OF THE INVENTION

This invention comprises a new mechanical dryer equipment for residual biomass which allows for the mechanical reduction of moisture content below 45% without resorting to dryers, while solving the two problems that residual plant biomasses have, those being inefficiency and high costs due to high levels of humidity when used in boilers.

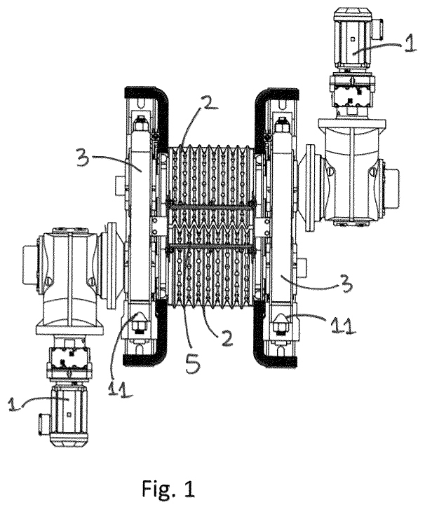

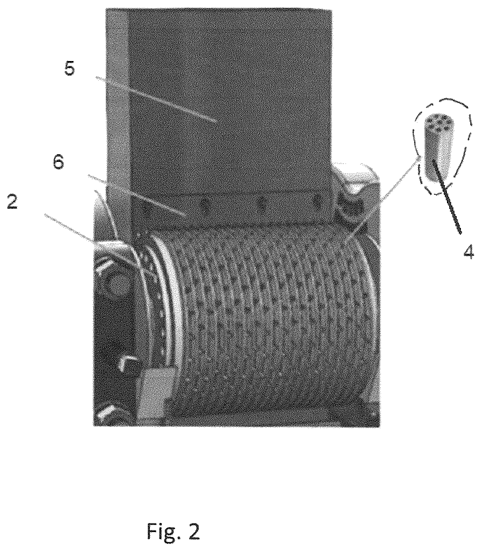

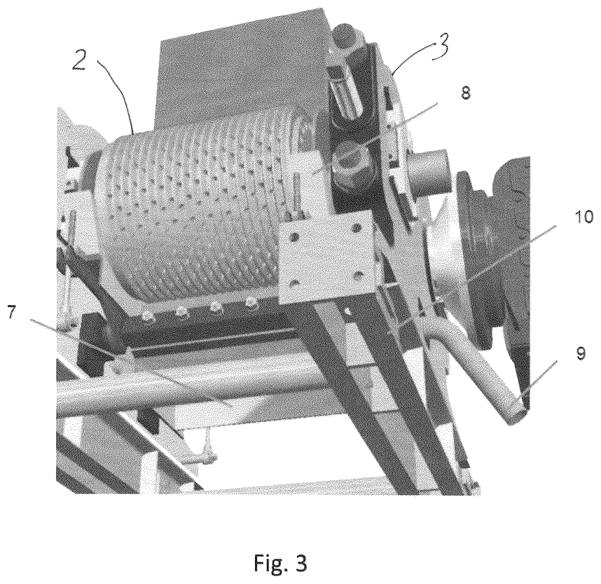

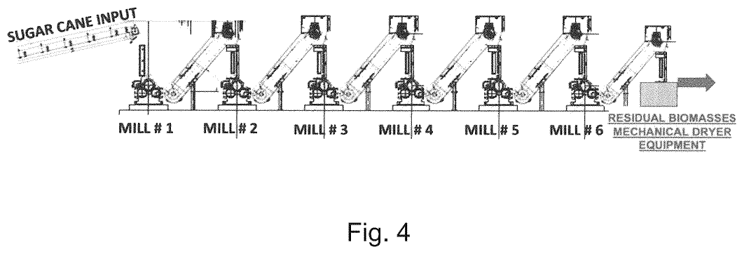

Thereby, FIGS. 1 to 3 show a residual biomasses mechanical dryer equipment as defined in the previous paragraph that comprises or consists, in general, without limitations, of the following parts or components:
Electric or hydraulic geared motors 1 rotate the rotating elements of the equipment and dry the biomass.
Metallic pressure cylinders 2 are moved or actuated directly by the geared motors 1 and are assembled on individual axes and mounted on two metallic housings 3. These cylinders 2 can be slotted or toothed in such a way as to ensure the greatest compression according to the physical conditions of the biomass being processed. They have removable nozzles 4 that are inserted into holes made on the body of the cylinders 2, and radially oriented and connected to liquid drainage evacuation passages 22 perforated for the biomass fluids along the entire length of the cylinder 2. These nozzles 4 may correspond to but are not limited to those defined in Colombian U.S. Pat. No. 15,259,626. The use of other types of removable nozzles that fulfill this specific function and have multiple perforations is also contemplated in this document.
A vertical feeder 5 located in the upper part of the cylinders 2, especially where these cylinders 2 join and their grooves or teeth are interlocked, and where the vertical feeder 5 allows the conduction or feeding of biomass to the compression area of the cylinders 2. This vertical feeder 5 has a cleaning element 6 in its lower part that corresponds to a “scraper” type component whose function is to keep the grooves of the cylinders 2 clean.
A lower outlet 7 through which the dry biomass that has been separated from the compression zone between the cylinders 2 flows freely by gravity, and where an element that conducts or takes the dry and separated biomass to a boiler can be installed, while making the liquids extracted from the biomass flow towards a sealed reservoir 8 located at the ends of the two cylinders 2, on the sides of the equipment, where the liquids that have been extracted from the biomass accumulate, and where if necessary, the reservoir can be connected to a vacuum pump.
Hoses 9 connected to the reservoir 8 through which the processed biomass liquid is taken out of the system, to be used by the factory; and
Tracks or lateral guides 10 on which the cylinders 2 can be moved by sliding and that allow the separation between the two toothed cylinders 2 to be easily adjusted according to the type of biomass being treated, thereby achieving the optimal compression force between the cylinders 2. It also serves to separate the cylinders 2 in case they must be replaced when they wear out naturally, or to carry out maintenance tasks easily and quickly.

Thus, the equipment in this invention reduces humidity in the biomasses to levels close to 40%, which optimizes the operation of the boilers, allowing the use of the calorific value in the biomasses, but maintaining the economic viability of the process and generating a positive energy balance.

In a preferred modality, the pressure cylinders 2 that are part of the equipment for this invention can be alternatively cast in different materials depending on the characteristics of the biomass being processed, these materials being cast iron, alloy cast steel, stainless steel, among others, or combinations of these materials without limitations. In addition, in another alternative modality, the rollers 2 can also be manufactured in high-performance plastics, depending on the biomass being processed, or by using other materials that are suitable given their resistance and characteristics, without limitations.

Thus, thanks to the aforementioned components and their respective modalities, the biomasses to be processed are subjected to a compression of a variable nature between the cylinders 2 and are adjustable depending on the characteristics of the biomass being processed, with speeds of equally controlled rotation.

However, in another modality of the invention, the nozzles 4 that are located in the perforations of the cylinders 2 are each equipped with multiple conical perforations (that is, more than one), which capture and direct the liquid in the biomasses that is compressed between the two grooved cylinders 2. Likewise, the divergent internal geometry of each of the nozzle perforations prevents clogging. The nozzles are selected according to the biomass being processed, following several criteria that are explained later.

In an alternative modality, the equipment for this invention can also optionally comprise a hydraulic head system 11, which allows constant compression between the two rollers 2 when the equipment is in operation, as illustrated in FIG. 1.

In addition to the above, in one modality of the invention, the vertical feeder 5 can also have a biomass push system that allows constant feeding of the cylinders 2, if required by the particular condition of the biomass.

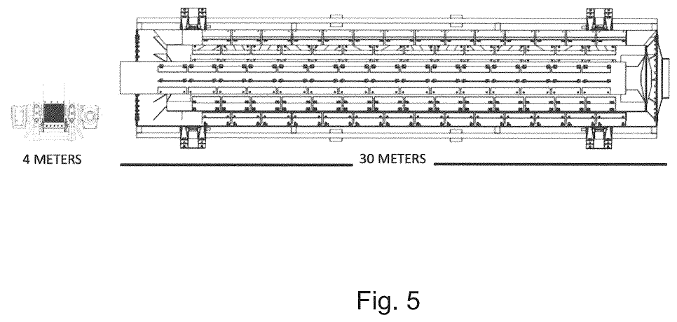

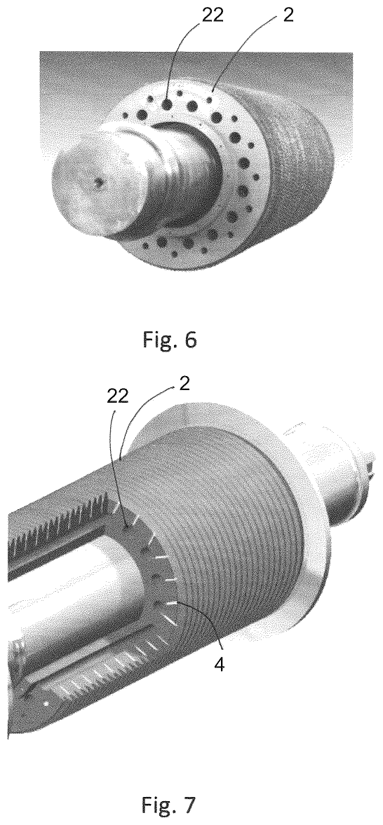

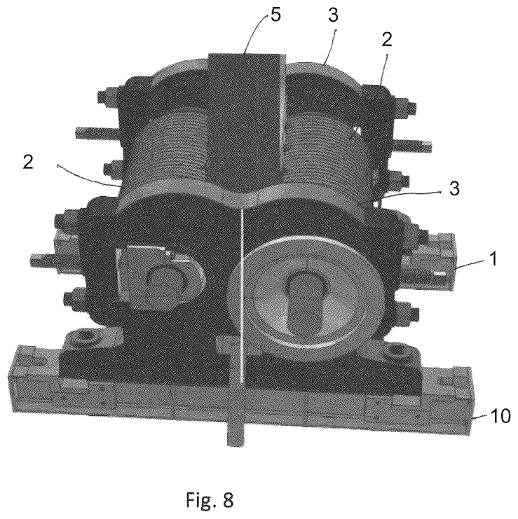

According to the preferred modalities defined in the previous paragraphs, it is evident that the drying equipment in this invention, in comparison with conventional rotary drying equipment, has a lower manufacturing cost due to its inexpensive and easy-to-find components, while its energy consumption is lower and it occupies less space in the plant to be installed, a fact that can be seen more clearly in FIG. 5, where a comparison is made between the size of the equipment of this invention and a typical rotary dryer used in the industry. The typical rotary dryer for 50 tons per hour can have an average length of 30 meters, while the equipment in this invention with the same capacity has a length of approximately 4 meters, resulting in a considerable reduction of space. Once again, the dimensions mentioned above serve just as an example. The equipment can be designed and manufactured for any size depending on the size of the biomass to be dried.

A lower energy consumption is achieved thanks to the inclusion of only two moving elements, which correspond to the cylinders 2 as shown in FIGS. 1 to 3 and defined in detail above, which have a much lower energy cost than traditional dryers given that these conventional dryers have a plurality of parts and must support the weight of the biomass along its structure, move it permanently and make it advance along its entire length.

Therefore, the equipment in this invention has a considerable advantage as compared to the most current technologies, thus providing a solution to the problems based on having a basic principle that does not include working with hot gases, or large tubular structures, while occupying minimal spaces in factories, and considerably reducing the cost of both acquisition, manufacture, and maintenance.

Although this invention has been defined in terms of the modalities and/or preferred configurations that allow for the desired result, it is then understood that within this disclosure the multiple modifications and/or alternatives that can be derived in an obvious way by a skilled person are contemplated. That is why the scope of this invention is not defined solely by the preferred implementations defined herein, but, on the contrary, it is entirely defined by the appended claims.

1. A residual biomass mechanical dryer assembly comprising:
metallic pressure cylinders each having a respective motor for rotation thereof, said cylinders each having a respective body and axis and being mounted on metal housings, said cylinders being grooved or toothed and said cylinders each having axially extending ducts formed in said body for draining biomass liquids, said cylinders having radially extending perforations extending between an outer surface thereof and said ducts;
nozzles disposed in said perforations;
a vertical feeder located over said cylinders, said vertical feeder having a scraping cleaning element on a lower part thereof;
a lower outlet for separated dry biomass;
a reservoir located laterally to said cylinders and being fluidically connected to said ducts; and
a liquid biomass outlet hose connected to said reservoir.

2. The biomass drying equipment according to claim 1, wherein the pressure cylinders are made of cast iron, alloy cast steel, stainless steel, high-performance plastics, or combinations thereof.

3. The biomass drying equipment according to claim 1, wherein said nozzles are each provided with conical perforations.

4. The biomass drying equipment according to claim 1, comprising a biomass push system for the constant feeding of the cylinders.

5. The biomass drying equipment according to claim 1, wherein said lower outlet has a conductive element that receives the dry biomass that falls by gravity and transports the dry biomass to a boiler.

6. The biomass drying equipment according to claim 1, wherein said reservoir is connected to a vacuum pump.

7. The biomass drying equipment according to claim 1, comprising a hydraulic headstock system that maintains constant compression between the cylinders.

8. The biomass drying equipment according to claim 1, comprising tracks or lateral guides for positioning the cylinders.
